(19) United States
(12) Patent Application Publication
(10) Pub. No.: US 2007/0152624 A1
(43) Pub. Date: Jul. 5, 2007

(54) Motor system, control method thereof, and compressor using the same

(75) Inventors: Koji Hamaoka, Gwangju-city (KR); Han-joo Yoo, Gwangju-city (KR); Pyeong-ki Park, Gwangju-city (KR); Jeong-ho Seo, Gwangju-city (KR); Kwang-kyo Oh, Gwangju-city (KR); Hun-yub Bae, Gwangju-city (KR); Yun-jeong Kim, Gwangju-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/642,884

(22) Filed: Dec. 21, 2006

(30) Foreign Application Priority Data
Dec. 29, 2005 (KR) 2005-0133857

(51) Int. Cl. H02P 21/00

(52) U.S. Cl. 318/805

(57) ABSTRACT

A motor system includes a BLDC (brushless direct current) motor; an inverter driving the BLDC motor; a current detector detecting a direct current of the inverter; an induced voltage detector detecting an induced voltage of the BLDC motor; and a controller controlling at least one of an output voltage and an output frequency of the inverter based on the direct current detected by the current detector and the induced voltage detected by the induced voltage detector.

### CROSS-REFERENCE TO RELATED APPLICATIONS

This application claims the benefit of Korean Patent Application No. 2005-0133857, filed on Dec. 29, 2005, in the Korean Intellectual Property Office, the disclosure of which is incorporated herein by reference.

### BACKGROUND OF THE INVENTION

1. Field of the Invention

The present invention relates to a motor system, a control method thereof, and a compressor using the same, and more particularly, to a motor system with a simple circuit, low cost, and high performance, a control method thereof, and a compressor using the same.

2. Description of the Related Art

A typical motor system including a motor such as a BLDC (brushless direct current) generally includes a converter to convert an alternating power source into a direct power source, an inverter to invert the direct power source to an alternating power source to be provided to the BLDC motor, an induced voltage detector to detect a position of a motor rotator and a controller to output an electric-conduction pattern of the inverter. The inverter generally includes a plurality of switching elements and a driver to drive the plurality of switching elements. The motor system further generally includes resistors interposed between the converter and the inverter and detects an over-current supplied to the motor.

FIG. 1 is a waveform diagram illustrating a 120-degree square wave signal used to drive the motor system. The motor system, which is a sensorless type, is driven by a 120-degree square wave 1, estimates a position of a motor rotator based on a counter-electromotive voltage 2 detected by a counter-electromotive detector, and performs appropriate phase commutation based on a point of time when the position of the motor rotator is estimated.

However, this type of a 120-degree driving system has disadvantages, such as, for example, a poor noise characteristic over a vector control system and a limited range of maximum driving for the same load torque due to a small conduction angle.

As an alternative to the 120-degree driving system, a sensorless speed vector control system including a motor current detector, a CPU for performing a high-speed operation, etc., has been proposed. Japanese Patent Publication No. 2003-189673 discloses a vector control method of a BLDC motor including a motor current detector, a motor speed estimation algorithm, a d-axis current control, etc.

FIG. 2 is a block diagram illustrating a driving system of the Japanese Patent Publication No. 2003-189673.

Referring to FIG. 2, a current power source 3 supplies direct power to an inverter circuit 4. The inverter circuit 4 has six switching elements configured in the form of a three-phase full-bridge and inverts the direct power to three-phase alternating power to be supplied to a motor 7 which is a BLDC motor. A controller 5 generates a PWM (pulse width modulation) command signal to drive the motor 7 and inputs a generated signal to the inverter circuit 4. Two current sensors 6 are direct current sensors that detect a phase of an alternating current precisely as well as a magnitude of the alternating current. Current output from the currents sensors 6 is input to the controller 5. Then the controller 5 performs an operation for the input current to output the PWM command signal appropriate in driving the motor 7.

The two current sensors 6 detect a U-phase current and a V-phase current of the current flowing into the motor 7, respectively. The detected current is input to the controller 5 through an A/D conversion. The controller 5 performs a three-phase/two-phase conversion and a d-q axis conversion based on a vector control theory to obtain a d-axis current and a q-axis current. The controller 5 estimates a position of a rotator based on the phase current detected by the current sensors 6 and using a predetermined motor equation. The controller 5 outputs a PWM command pattern through which a sinusoidal current to drive the motor 7 can be generated, based on the estimated position of the rotator 7. The vector control theory, which is a theory developed using the sinusoidal current, requires the PWM command pattern to generate the sinusoidal current in order to achieve exact vector control. The controller 5 generates and outputs the PWM command pattern through an operation to make the obtained d-axis current equal to a preset target value depending on a load condition.

However, since such a position estimation algorithm has relatively many errors and requires the positional information for the d-q axis conversion, it is less accurate than when a position sensor such as a rotary encoder is used. However, the vector control method employing the position estimation algorithm has a structure simpler than a structure including the position sensor, which is relatively expensive and has to be attached to a mechanical unit of the motor. In addition, with use of a compressor, the motor is mounted within an airtight container and the inside of the airtight container has conditions of high temperature, oil, refrigerant, etc. Under such conditions, since the position sensor, such as the rotary encoder, cannot be attached to the mechanical unit of the motor to ensure the reliability of the motor, a system with no position sensor has been employed for various areas, including in refrigerators, air conditioners, washing machines, etc.

However, the above-mentioned sensorless vector control system has the following problems. First, two or more required current sensors increase a scale of a circuit and production costs. Second, an expensive high-speed CPU is necessary since a complex operation, such as computation of the PWM command pattern, is required for three-phase/two-phase conversion, the d-q axis conversion, and the generation of the sinusoidal current based on the current detected through the current sensor. Third, since current has to be sensed in response to a complex operation of a PWM pattern to generate the sinusoidal current, an A/D conversion must be minutely determined by timing at high speed, thus requiring an expensive high-speed CPU such as a DSP (digital signal processor).

### SUMMARY OF THE INVENTION

Accordingly, it is an aspect of the present invention to provide a motor system with a simple circuit, low costs, and high performance, a control method thereof, and a compressor using the same.

Additional aspects and/or advantages of the present invention will be set forth in part in the description which follows and, in part, will be apparent from the description, or may be learned by practice of the present invention.

The foregoing and/or other aspects of the present invention are achieved by providing a motor system including a BLDC (brushless direct current) motor; an inverter driving the BLDC motor; a current detector detecting a direct current of the inverter; an induced voltage detector detecting an induced voltage of the BLDC motor; and a controller controlling at least one of an output voltage and an output frequency of the inverter based on the direct current detected by the current detector and the induced voltage detected by the induced voltage detector.

According to another aspect of the present invention, the BLDC motor includes a stator having three coils arranged in three phases and a rotator rotably arranged with respect to the stator. The inverter includes three pairs of switching elements switching a flow of current flowing into the respective coils and a flow of current flowing out of the respective coils.

According to another aspect of the present invention, the controller obtains a d-axis current based on the direct current of the inverter and the induced voltage of the BLDC motor and controls each of the three pairs of switching elements so that the d-axis current reaches a predetermined target value.

According to another aspect of the present invention, the controller controls the respective switching elements based on a square or trapezoid waveform.

According to another aspect of the present invention, the controller controls the respective switching elements such that an electric conduction angle is more than 120° and less than 165°.

According to another aspect of the present invention, the controller determines that, in intervals in which three switching elements operate, each current of two phases in the same direction is half of the direct current of the inverter.

According to another aspect of the present invention, the controller performs PWM (pulse width modulation) for one of the switching elements in one phase.

According to another aspect of the present invention, the current detector detects the direct current of the inverter in an interval in which a pulse is in an on state during the PWM.

According to another aspect of the present invention, the induced voltage detector detects the induced voltage of a phase in which one pair of switching elements is in an off state.

The foregoing and/or other aspects of the present invention are also achieved by providing a motor system including a BLDC motor; an inverter driving the BLDC motor; a current estimator estimating a current of the BLDC motor; and a controller controlling at least one of an output voltage and an output frequency of the inverter by performing nonsinusoidal wave driving with an electric conduction angle of more than 120° and less than 165° based on the estimated current of the BLDC motor.

The foregoing and/or other aspects of the present invention are also achieved by providing a motor system that drives a compressor, the compressor including a chamber accommodating fluids, and a compressing member movably disposed in the chamber. The motor system moves the compressing member such that the fluids are compressed.

The foregoing and/or other aspects of the present invention are also achieved by providing a control method of a motor system including a BLDC motor and an inverter driving the BLDC motor, comprising detecting a direct current of the inverter; detecting an induced voltage of the BLDC motor; and controlling at least one of an output voltage and an output frequency of the inverter based on the detected direct current and the detected induced voltage.

According to another aspect of the present invention, the BLDC motor includes a stator having three coils arranged in three phases and a rotator rotably arranged with respect to the stator, and the inverter includes three pairs of switching elements switching a flow of current flowing into the respective coils and a flow of current flowing out of the respective coils.

According to another aspect of the present invention, the controlling at least one of the output voltage and the output frequency of the inverter includes obtaining a d-axis current based on the detected direct current of the inverter and the detected induced voltage of the BLDC motor and controlling each of the three pairs of switching elements so that the d-axis current reaches a predetermined target value.

According to another aspect of the present invention, the controlling at least one of the output voltage and the output frequency of the inverter further includes controlling the respective switching elements based on a square or trapezoid waveform.

According to another aspect of the present invention, the controlling at least one of the output voltage and the output frequency of the inverter further includes controlling the respective switching elements so that an electric conduction angle is more than 120° and less than 165°.

According to another aspect of the present invention, the controlling at least one of the output voltage and the output frequency of the inverter further includes determining that, in intervals in which the switching elements operate, each current of two phases in the same direction is half of the direct current of the inverter.

According to another aspect of the present invention, the controlling at least one of the output voltage and the output frequency of the inverter further includes performing PWM for one of the switching elements in one phase.

According to another aspect of the present invention, the detecting the direct current includes detecting the direct current of the inverter in an interval in which a pulse is in an on state during the PWM.

According to another aspect of the present invention, the detecting the induced voltage includes detecting the induced voltage of a phase in which one pair of switching elements is in an off state.

The foregoing and/or other aspects of the present invention are also achieved by providing a control method of a motor system including a BLDC motor and an inverter driving the BLDC motor, where the control method includes estimating a current of the BLDC motor; and controlling at least one of an output voltage and an output frequency of the inverter by performing nonsinusoidal wave driving with an electric conduction angle of more than 120° and less than 165° based on the estimated current of the BLDC motor.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a waveform diagram illustrating a 120-degree square wave used in driving a conventional motor system;

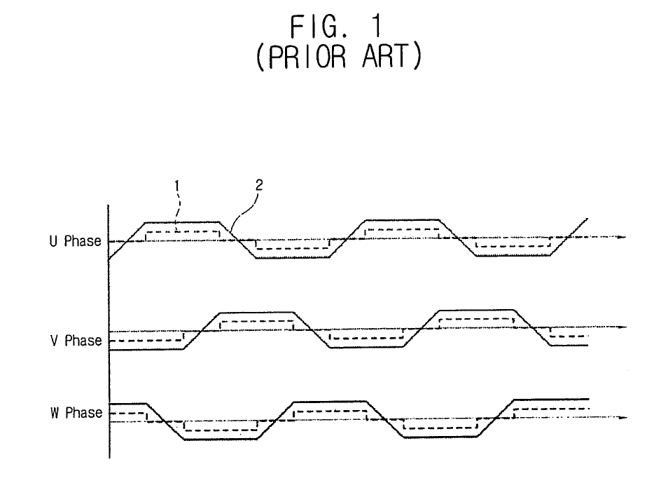

FIG. 2 is a block diagram illustrating a driving system of the conventional motor system;

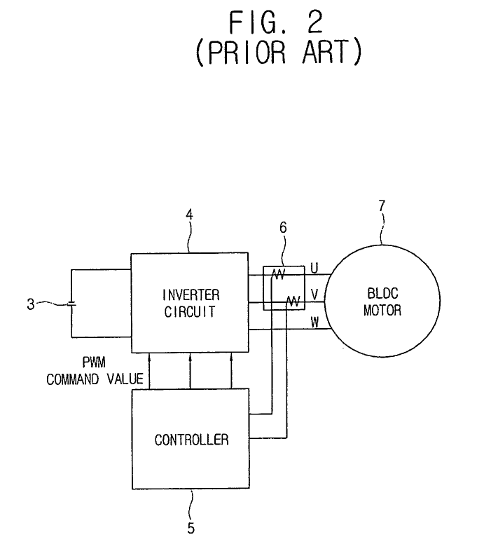

FIG. 3 is a block diagram illustrating a configuration of a motor system according to a first embodiment of the present invention;

FIG. 4 is a waveform diagram of signals used in driving the motor system according to the first embodiment of the present invention;

FIG. 5 is a graph showing characteristics of a d-axis current Id and a motor current Iu according to the first embodiment of the present invention;

FIG. 6 is a view illustrating a relationship between a direct current and a phase current according to a second embodiment of the present invention;

FIG. 7 is a waveform diagram showing an actual U-phase current, an estimated U-phase current and a direct current according to the second embodiment of the present invention; and

FIG. 8 is a flow chart illustrating an operation of the motor system according to the second embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

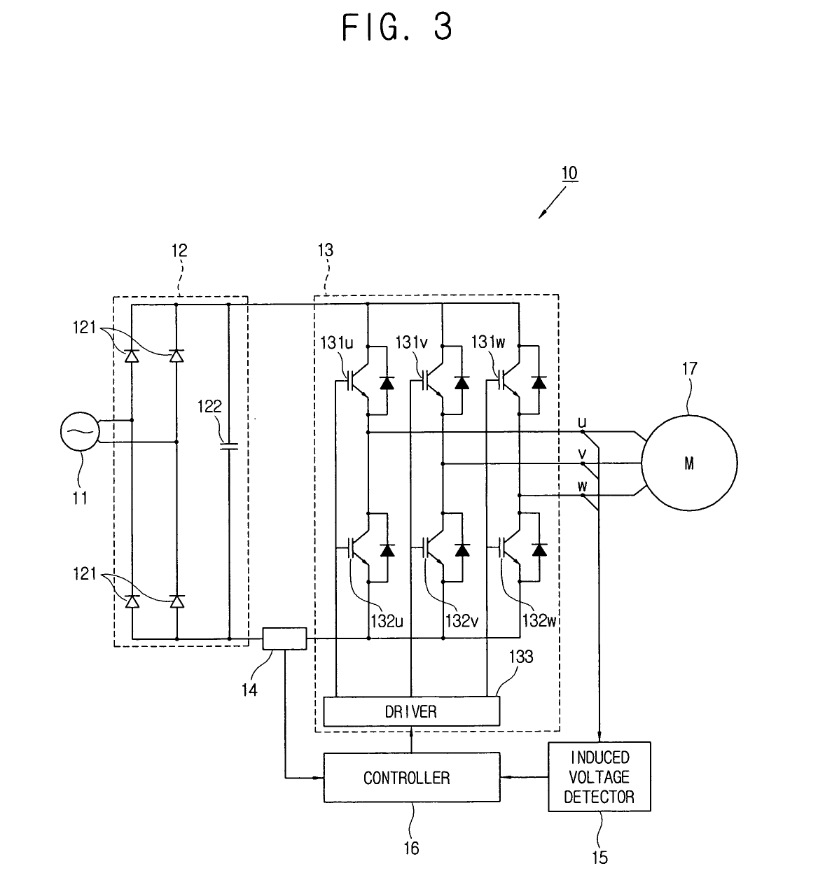

FIG. 3 is a block diagram illustrating a configuration of a motor system 10 according to a first embodiment of the present invention. The motor system 10 includes a BLDC motor 17, an inverter 13 driving the BLDC motor 17, a current detector 14 detecting a direct current of the inverter 13, an induced voltage detector 15 detecting an induced voltage of the BLDC motor 17 and a controller 16 controlling at least one of an output voltage and an output frequency of the inverter 13 based on the detected direct current and the detected induced voltage.

The BLDC motor 17 includes a stator having three coils arranged in three phases and a rotator (i.e., a rotor) arranged rotably with respect to the stator.

The motor system 10 may further include a converter 12 receiving an alternating current from a commercial power source 11 and converting the received alternating current into a direct current. The converter 12 includes four diodes 121 configured in the form of a two-phase bridge and a smoothing capacitor 122 performing full-wave rectification. As an alternative example, the converter 12 may include a dual voltage circuit (not shown) which performs half-wave rectification.

The inverter 13 has six switching elements 131u, 131v, 131w, 132u, 132v and 132w (hereinafter abbreviated as upper switching elements 131 and lower switching elements 132) interconnected in the form of a three-phase bridge and a driver 133 to switch on/off the switching elements 131 and 132. The three pairs of switching elements 131 and 132 switch a flow of current flowing into the respective coils arranged in the stator of the BLDC motor 17 and a flow of current flowing out of the respective coils. By switching on/off the switching elements 131 and 132, which are under the control of the controller 16, the driver 133 enables the inverter 13 to output a three-phase alternating current with a predetermined voltage and frequency. The BLDC motor 17 operates when the outputted three-phase alternating current is supplied to the BLDC motor 17.

The current detector 14 is connected in series between the converter 12 and the inverter 13. The direct voltage output from the converter 12 is applied to the inverter 13 via the current detector 14. The current detector 14 may be implemented by using shunt resistors. The current detector 14 may have an over-current detecting function to prevent the switching elements 131 and 132 from being damaged by over-current.

The controller 16 generates a signal to switch on/off the switching elements 131 and 132 and supplies the generated signal to the inverter 13 so that the inverter 13 drives the BLDC motor 17 with the predetermined voltage and frequency.

An output voltage of the inverter 13 is applied to the induced voltage detector 15. The BLDC motor 17 generates an induced voltage while the rotator, which is a permanent magnet, rotates with respect to the coils of the stator. Accordingly, when the induced voltage detector 15 detects the induced voltage of a phase in which a pair of upper and lower switching elements 131 and 132 of the inverter 13 is simultaneously switched off, a position of the rotator may be estimated.

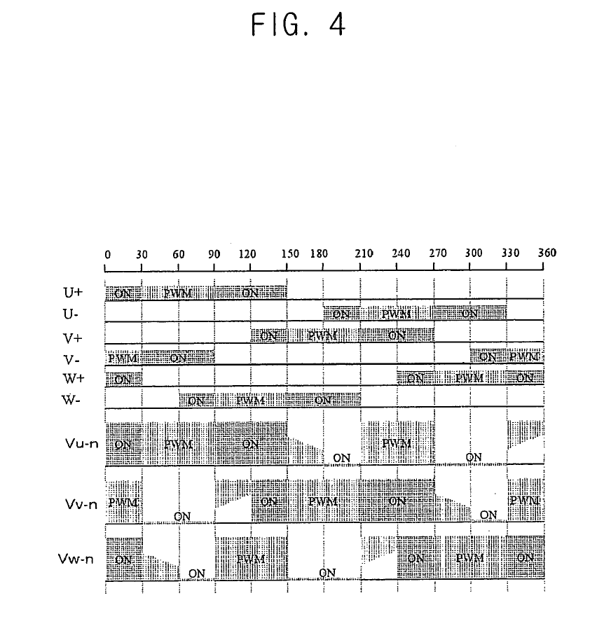

FIG. 4 is a waveform diagram of signals used in driving the motor system 10 according to the first embodiment of the present invention. Reference numerals “U+” to “W−” denote on/off signals of the driver 133 switching on/off the switching elements 131 and 132. Reference numerals “Vu-n” to “Vw-n” denote waveforms of output voltages of U, V and W phases, respectively. Portions denoted by reference character “PWM” indicate that a PWM operation is performed in the portions. The controller 16 controls the inverter 13 based on a 150-degree square wave. The driver 133 drives the switching elements 131 and 132 with a carrier frequency of several kHz to 20 kHz and a duty cycle of 0 to 100% under control of the controller 16.

In square wave driving of the motor system 10, according to the first embodiment of the present invention, a PWM with equal width may be used for the PWM control. In other words, a simple PWM control can be utilized since the switching elements 131 and 132 may be driven with a constant duty cycle irrespective of their output phases.

In contrast, in the conventional 120-degree square wave driving, only two switching elements can maintain an on state at each point of time during the driving of the motor. In the first embodiment, however, since 150-degree electric conduction is performed, there exist portions where three overlapping switching elements 131u-w and 132u-w operate. In FIG. 4, these overlapping portions are a 0° to 300 portion on “U+”, a 180° to 210° portion on “U−”, a 120° to 150° portion on “V+”, a 300° to 330° portion on “V−”, a 240° to 270° portion on “W+”, a 60° to 90° portion on “W−.”

Since each of the switching elements 131 and 132 for each of three phases is switched on, induced voltages indicated in “U+” to “W−” are shown in these overlapping portions. However, for portions after the overlapping portions, there exist intervals in which both of the upper and lower switching elements for one phase are switched off (for example, a 30° to 60° interval at the W phase). Accordingly, since the induced voltages are generated in these intervals, it is possible to detect the induced voltages and estimate the position of the rotator. Since a position detecting interval typically requires approximately 15°, the maximum electric conduction angle in the first embodiment is 165°.

Hereinafter, calculation and control of the d-axis current based on the above-described vector in driving the motor system 10 according to the first embodiment will be described through a simulation and an experiment.

Typically, in obtaining the d-axis current in order to perform the vector control by sinusoidal wave driving, first the three-phase/two-phase conversion is performed using a determinant, such as the following Equation 1.

$$( \begin{matrix}Ia \\ Ib\end{matrix} ) = ( \begin{matrix}\sqrt{3 / 2} & 0 \\ - \sqrt{2} / 2 & - \sqrt{2}\end{matrix} ) ( \begin{matrix}Iu \\ Iv\end{matrix} ) \qquad Equation 1$$

### Here, Iu and Iv denote a motor current of the U and V phases, respectively, and Ia and Ib denote a two-phase converted current of the motor current Iu and Iv.

Next, the two-phase converted current Ia and Ib is converted into a d-q axis current using a determinant, such as the following Equation 2.

$$( \begin{matrix}Id \\ Iq\end{matrix} ) = ( \begin{matrix}cos & ω t & sin & ω t \\ - sin & ω t & cos & ω t\end{matrix} ) ( \begin{matrix}Ia \\ Ib\end{matrix} ) \qquad Equation 2$$

### Here, Id and Iq denote the d-axis current and the q-axis current, respectively, and co denotes an angular speed of the rotator.

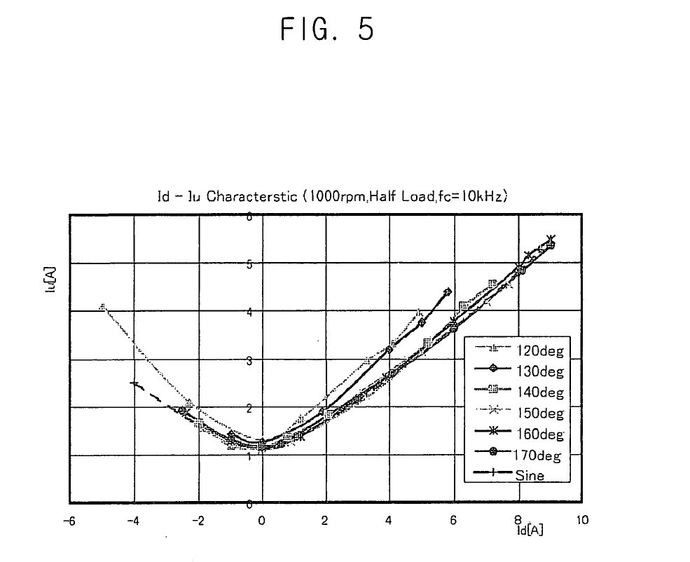

A relationship between the d-axis current obtained in Equation 2 and an actual motor current in various phase conditions is shown in FIG. 5. FIG. 5 is a graph showing characteristics of the d-axis current Id and the motor current Iu in this embodiment. In FIG. 5, as operation conditions, the number of revolutions is 1000 rpm, a carrier frequency is 10 kHz, and an electric conduction angle is a parameter. The graph of FIG. 5 shows that the electric conduction angle of more than 140° has a characteristic similar to the sinusoidal wave driving, while the electric conduction angle of 120° to 130° shows a characteristic slightly different from the sinusoidal wave driving. In other words, the d-axis current can be obtained in square wave driving through expansion of the same equation as the sinusoidal wave driving.

Moreover, since even the electric conduction angle of 120° to 130° shows nearly the same trend as the sinusoidal wave driving, even though there is a slight difference in data, it is concluded that it is possible to control the d-axis current for square wave driving. In other words, it can be said that the d-q conversion expanded originally based on the sinusoidal wave is effective for the square wave driving. It is understood that this is because the overlapping square wave driving makes a current waveform approach the sinusoidal wave. Even when other operation conditions, for example, a rotation speed and a load state, are varied, a result showing substantially the same characteristic as the graph of FIG. 5 is obtained.

Next, an operation of the motor system 10 according to the first embodiment will be described in more detail. First, in the first embodiment, it is assumed that the output waveform is nonsinusoidal, for example, a square or a trapezoid with the electric conduction angle of 120° to 165°.

When the square or trapezoid waveform is used to detect of the position of the rotator, the motor current cannot have a complete sinusoidal wave, and therefore, there is a possibility of the occurrence of large errors as compared to sinusoidal wave driving. Accordingly, the position of the rotator can be exactly detected when the induced voltage detector 15 detects an induced voltage in an interval in which the upper and lower switching elements 131 and 132 of the inverter 13 are simultaneously switched off, as described above. For example, the induced voltage detector 15 can estimate the position of the rotator by directly detecting a zero-cross point of the induced voltage or by performing an A/D conversion for the induced voltage and then predicting the zero-cross point.

Since the induced voltage is detected six times per electrical angle of 360° (i.e., one time per every 60°), it is sufficient for a system with slow variation of a load, such as a refrigeration system or a refrigerator. In addition, while it is illustrated in the first embodiment that the detection of the induced voltage is performed for all of the three phases, as an alternative embodiment, the induced voltage may be detected two times per electrical angle of 360° (i.e., one time per every 180°) for only one phase. This alternative embodiment also allows the present invention to be put into practical use in the system with slow variation of the load.

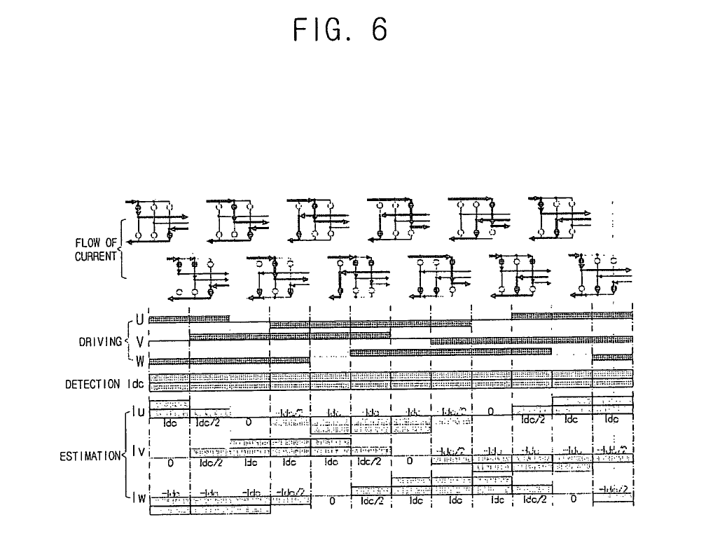

Next, the estimation of the motor current in the motor system 10 according to this second embodiment will be described. As shown in FIG. 6, the controller 16 controls the driver 133 to perform the PWM operation for only one of two or three switching elements 131u-w and 132u-w, which are switched on. This is called “single-phase ARM modulation”. On the other hand, the PWM operation for two of a plurality of switching elements is called “two-phase ARM modulation”.

For typical sinusoidal PWM, three-phase ARM modulation is used and PWM duty cycles are varied depending on the phase are output to the U, V and W phases. Accordingly, for the sinusoidal PWM, since a current is complicatedly varied in one period of the carrier frequency and there is a need of a high-speed A/D conversion and a complex timing generation technique in order to detect the motor current from a direct current through an A/D conversion, an expensive high-speed CPU is required.

However, as in the motor system 10 according to this embodiment, when the single-phase ARM modulation is performed for square wave driving, a current state in an interval of PWM in which the switching elements are switched on is not varied. Accordingly, since the current may be measured in this interval, it is possible to detect the motor current with simple timing. In addition, an A/D conversion speed is not required to be high as compared to the three-phase ARM modulation, and accordingly it is possible to implement the second embodiment of the present invention with an inexpensive low-speed CPU.

Next, a method of estimating the motor current from the direct current detected according to the above-described method will be described. A direct current Idc detected in each interval in FIG. 4 may be represented as follows.
Interval 0 [0°-30°]: Idc=Iw+Iu=−Iv
Interval 1 [30°-60°]: Idc=Iu=−Iv
Interval 2 [60°-90°]: Idc=Iu=−Iv−Iw
Interval 3 [90°-120°]: Idc=Iu=−Iw
Interval 4 [120°-150°]: Idc=Iu+Iv=−Iw
Interval 5 [150°-180°]: Idc=Iv=−Iw
Interval 6 [180°-210°]: Idc=Iv=−w−Iu
Interval 7 [210°-240°]: Idc=Iv=−Iu
Interval 8 [240°-270°]: Idc=Iv+Iw=−Iu
Interval 9 [270°-300°]: Idc=Iw=−Iu
Interval 10 [300°-330°]: Idc=Iw=−Iu−Iv
Interval 11 [330°-360°]: Idc=Iw=−Iv

In this embodiment, an overlapping current is simply assumed to be ½ of the direct current Idc. As a result, for example, the U-phase motor current Iu may be represented as follows.
Interval 0: Idc/2
Interval 1: Idc
Interval 2: Idc
Interval 3: Idc
Interval 4: Idc/2
Interval 5: 0
Interval 6: −Idc/2
Interval 7: −Idc
Interval 8: −Idc
Interval 9: −Idc
Interval 10: −Idc/2
Interval 11: 0

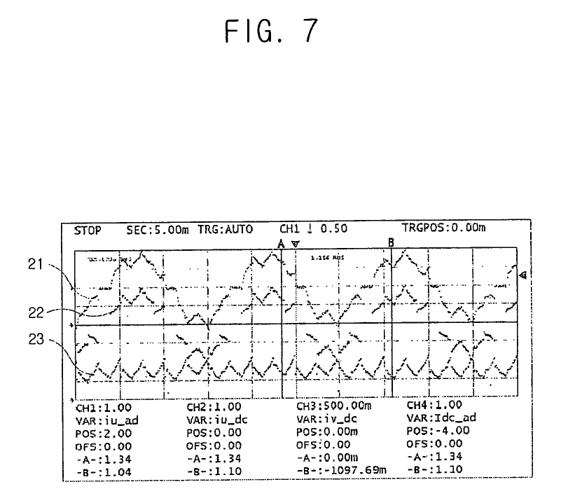

As described above, by simplifying the motor current in each interval, calculation related to the vector control can be achieved even with an inexpensive low-speed CPU. A result of the estimation of the motor current according to the method of this embodiment is shown in FIG. 7. In FIG. 7, reference numeral 21 denotes an actual motor current, reference numeral 22 denotes an estimated motor current, and reference numeral 23 denotes the direct current Idc. As can be seen from FIG. 7, the operation of the motor system according to this embodiment is simple, and the estimated motor current is comparatively equal to the actual motor current.

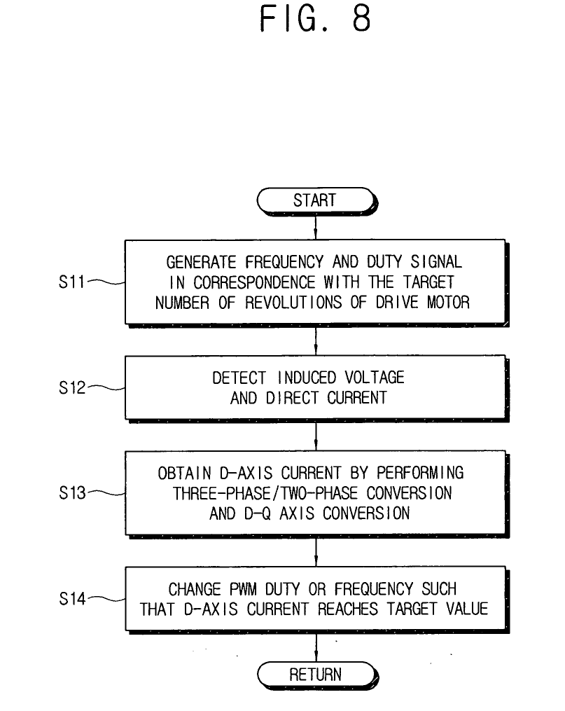

Hereinafter, a control method of the motor system 10 according to this embodiment will be described. FIG. 8 is a flow chart illustrating an operation of the motor system 10. First, the controller 16 generates a frequency and a duty signal to enable the BLDC motor 17 to reach a target number of revolutions and inputs the generated frequency and duty signal to the inverter 13 to drive the BLDC motor 17 (S11). The induced voltage detector 15 detects an induced voltage, and the direct current detector 14 detects the direct current Idc of the inverter 13 (S12). The d-axis current is obtained by performing the three-phase/two-phase conversion and the d-q axis conversion based on the position information found with the induced voltage and the motor current estimated according to the detected direct current Idc (S13). The inverter 13 is controlled by varying a PWM duty cycle or frequency to make the obtained d-axis current equal to a predetermined target value (S14).

For a typical vector control, since an obtained result is immediately reflected on an output voltage for the purpose of obtaining a high speed response, a control is performed according to a method of obtaining a present d-axis current from a previous motor current. Thus, the typical vector control requires an expensive high-speed CPU.

However, the motor system 10 according to this embodiment performs a proportional integral (PI) control with a difference between an actual d-axis current and a target value and performs an equal width PWM, thereby relatively slowly changing an output duty cycle as compared to the sinusoidal wave driving. Accordingly, the present invention of this embodiment may be implemented using an inexpensive CPU. If no response is obtained with the output duty cycle, an output frequency may be changed.

In this manner, it is possible to control the d-axis current with a simple structure at a level equivalent to high performance vector control, and accordingly, it is possible to achieve low noise and high efficiency in driving the motor.

As described above, since the motor system 10 according to this embodiment detects the direct current by using the low-speed CPU and adjusts the output voltage or the output frequency based on the detected direct current, it can be usefully applied to a system with relatively slow variation of a load.

For example, the motor system 10 of this embodiment may be used to drive a compressor of a refrigeration system. In this case, the compressor of this embodiment includes a chamber accommodating fluids and a compressing member movably disposed in the chamber. The motor system 10 moves the compressing member in such a manner that the fluids in the chamber are compressed.

According to the above-described embodiment, the compressor of the refrigeration system can achieve high efficiency and low noise. In addition, since a load of the compressor of the refrigeration system is determined by a sucking pressure and a discharging pressure of the compressor, the refrigeration system has smooth variation of the load. When the motor system 10 of this embodiment is equipped within such a refrigeration system, both smaller size and lower costs of the system can be achieved.

In addition, since a refrigeration system, such as a refrigerator, cools a restricted space and accordingly has a small load variation range, the motor system 10 of this embodiment can be properly applied to the refrigerator. In addition, according to the present invention, miniaturization of the inverter allows for an increase in the volume of the motor system 10 and reduction of costs.

As apparent from the above description, the embodiments of the present invention provides a motor system with a simple circuit, low cost, and high performance, a control method thereof, and a compressor using the same.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A motor system comprising:
a BLDC motor;
an inverter driving the BLDC motor;
a current detector detecting a direct current of the inverter;
an induced voltage detector detecting an induced voltage of the BLDC motor; and
a controller controlling at least one of an output voltage and an output frequency of the inverter based on the direct current detected by the current detector and the induced voltage detected by the induced voltage detector.

2. The motor system according to claim 1, wherein the BLDC motor comprises a stator including three coils arranged in three phases and a rotator rotably arranged with respect to the stator, and the inverter comprises three pairs of switching elements switching a flow of current flowing into the respective coils and a flow of current flowing out of the respective coils.

3. The motor system according to claim 2, wherein the controller obtains a d-axis current based on the direct current of the inverter and the induced voltage of the BLDC motor and controls each of the three pairs of switching elements so that the d-axis current reaches a predetermined target value.

4. The motor system according to claim 2, wherein the controller controls the respective switching elements based on a square or trapezoid waveform.

5. The motor system according to claim 2, wherein the controller controls the respective switching elements such that an electric conduction angle is more than 120 degrees and less than 165 degrees.

6. The motor system according to claim 2, wherein the controller determines that, in intervals in which the three pairs of switching elements operate, each current of two phases in the same direction is half of the direct current of the inverter.

7. The motor system according to claim 2, wherein the controller performs PWM for one of the switching elements in one phase.

8. The motor system according to claim 7, wherein the current detector detects the direct current of the inverter in an interval in which a pulse is in an on state during the PWM.

9. The motor system according to claim 2, wherein the induced voltage detector detects the induced voltage of a phase in which one of the pairs of switching elements is in an off state.

10. A motor system comprising:
a BLDC motor;
an inverter driving the BLDC motor;
a current estimator estimating a current of the BLDC motor; and
a controller controlling at least one of an output voltage and an output frequency of the inverter by performing nonsinusoidal wave driving with an electric conduction angle of more than 120 degrees and less than 165 degrees based on the estimated current of the BLDC motor.

11. The motor system according to claim 1, wherein the motor system drives a compressor, the compressor comprising:
a chamber accommodating fluids, and
a compressing member movably disposed in the chamber,
the motor system moving the compressing member such that the fluids are compressed.

12. A control method of a motor system including a BLDC motor and an inverter driving the BLDC motor, comprising:
detecting a direct current of the inverter;
detecting an induced voltage of the BLDC motor; and
controlling at least one of an output voltage and an output frequency of the inverter based on the detected direct current and the detected induced voltage.

13. The control method according to claim 12, further comprising switching a flow of current into and out of respective coils of a stator that are arranged in three phases, wherein a rotator is rotably arranged with respect to the stator.

14. The control method according to claim 13, wherein the controlling at least one of the output voltage and the output frequency of the inverter comprises obtaining a d-axis current based on the detected direct current of the inverter and the detected induced voltage of the BLDC motor and controlling each of the three pairs of switching elements so that the d-axis current reaches a predetermined target value.

15. The control method according to claim 13, wherein the controlling at least one of the output voltage and the output frequency of the inverter further comprises controlling the respective switching elements based on a square or trapezoid waveform.

16. The control method according to claim 13, wherein the controlling at least one of the output voltage and the output frequency of the inverter further comprises controlling the respective switching elements so that an electric conduction angle is more than 120 degrees and less than 165 degrees.

17. The control method according to claim 13, wherein the controlling at least one of the output voltage and the output frequency of the inverter further comprises determining that, in intervals in which the three pairs of switching elements operate, each current of two phases in the same direction is half of the direct current of the inverter.

18. The control method according to claim 13, wherein the controlling at least one of the output voltage and the output frequency of the inverter further comprises performing PWM for one of the switching elements in one phase.

19. The control method according to claim 18, wherein the detecting the direct current comprises detecting the direct current of the inverter in an interval in which a pulse is in an on state during the PWM.

20. The control method according to claim 13, wherein the detecting the induced voltage comprises detecting the induced voltage of a phase in which one pair of switching elements is in an off state.

21. A control method of a motor system comprising a BLDC motor and an inverter driving the BLDC motor, comprising:
estimating a current of the BLDC motor; and
controlling at least one of an output voltage and an output frequency of the inverter by performing nonsinusoidal wave driving with an electric conduction angle of more than 120 degrees and less than 165 degrees based on the estimated current of the BLDC motor.

22. The motor system according to claim 3, wherein the d-axis current is obtained by performing three-phase/two-phase conversion and converting a two-phase converted current into a d-q axis current.

23. The motor system according to claim 1, further comprising a converter receiving an alternating current and converting the alternating current into the direct current.

24. The motor system according to claim 1, wherein the induced voltage is detected six times per electrical angle of 360 degrees, the induced voltage being detected for all of three phases of the motor system.

25. The motor system according to claim 1, wherein the induced voltage is detected two times per electrical angle of 360 degrees, the induced voltage being detected for one of three phases of the motor system.

26. A control method of a motor system including a BLDC motor and an inverter, comprising:
detecting an induced current of the BLDC motor;
detecting a direct current of the inverter; and
varying one of a PWM duty cycle and a PWM frequency to make a d-axis current obtained based on the detected induced current and detected direct current equal to a predetermined target value.
